(19) United States
(12) Patent Application Publication
(10) Pub. No.: US 2023/0133873 A1
(43) Pub. Date: May 4, 2023

(54) REMOTE MONITORING SYSTEM, REMOTE MONITORING APPARATUS, AND METHOD

(71) Applicant: NEC Corporation, Minato-ku, Tokyo (JP)

(72) Inventors: Takanori IWAI, Tokyo (JP); Kosei KOBAYASHI, Tokyo (JP); Yusuke SHINOHARA, Tokyo (JP); Koichi NIHEI, Tokyo (JP); Takashi YAMANE, Tokyo (JP); Masayuki SAKATA, Tokyo (JP)

(73) Assignee: NEC Corporation, Minato-ku, Tokyo (JP)

(21) Appl. No.: 17/910,411

(22) PCT Filed: Mar. 31, 2020
(86) PCT No.: PCT/JP2020/014946

§ 371 Date: Sep. 9, 2022

(51) Int. Cl. H04N 7/18; G06V 20/58

(52) U.S. Cl. CPC H04N 7/183; G06V 20/58

(57) ABSTRACT

An image reception unit receives an image from a vehicle through a network. An event prediction unit predicts an event based on the image received by the image reception unit. Based on an event result predicted by the event prediction unit an important area identification unit identifies an area related to the predicted event as an important area in the image. An image adjustment unit adjusts image quality concerning the important area, which is identified by the important area identification unit, in the image.

### TECHNICAL FIELD

The present disclosure relates to a remote monitoring system, a remote monitoring apparatus, and a method.

### BACKGROUND ART

A system that monitors a target through a camera image acquired from a vehicle is known. The camera image is taken by a camera disposed in the vehicle. As a related art, Patent Literature 1 discloses a monitoring system designed to monitor a target to be primarily monitored. The monitoring system described in Patent Literature 1 includes a central monitoring apparatus and a monitoring terminal apparatus. The central monitoring apparatus is installed at authorities such as a police station or a fire station. The monitoring terminal apparatus is disposed in a mobile object such as a passenger vehicle. The monitoring system is used by the authorities such as a police station or a fire station to centrally monitor a town for public safety.

The central monitoring apparatus transmits a primary monitor command to the monitoring terminal apparatus. The primary monitor command contains primary monitor target information for designating a target to be primarily monitored and a position to be primarily monitored. The monitoring terminal apparatus determines a time at which the passenger vehicle is to be present at the position to be primarily monitored, based on a current position of the passenger vehicle. At a time when the passenger vehicle is present at or in a vicinity of the position to be primarily monitored, the monitoring terminal apparatus acquires image information in which the target to be primarily monitored is enlarged and transmits the image information to the central monitoring apparatus. In Patent Literature 1, the central monitoring apparatus is able to acquire the image information, in which the target to be primarily monitored is enlarged, from the vehicle traveling at or in the vicinity of the position to be primarily monitored out of a plurality of passenger vehicles traveling randomly. Thus, an observer can monitor even details of the target to be primarily monitored without visiting a site of the target.

As another related art, Patent Literature 2 discloses a remote video output system designed to remotely control an autonomous vehicle. In Patent Literature 2, the autonomous vehicle transmits visual data taken by an in-vehicle camera to a remote-control center through a network. The autonomous vehicle is equipped with a camera filming a frontward area, a camera filming a rearward area, a camera filming a right-side area, and a camera filming a left-side area of the autonomous vehicle and transmits visual data taken by each of the cameras to the remote-control center.

The autonomous vehicle calculates a degree of danger using a danger prediction algorithm, and based on the calculated degree of danger, controls a resolution and a frame rate of the visual data to be transmitted to the remote-control center. When the degree of danger is less than or equal to a threshold value, the autonomous vehicle transmits visual data with a relatively low resolution or a low frame rate to the remote-control center. When the degree of danger is greater than a threshold value, the autonomous vehicle transmits visual data with a relatively high resolution or a high frame rate to the remote control-center.

An observer on a remote-control center side remotely monitors the autonomous vehicle by observing a relatively low-resolution image usually. In response to an increase in the degree of danger concerning the autonomous vehicle, the observer is able to remotely monitor the autonomous vehicle through a relatively high-resolution image. In Patent Literature 2, the observer can predict danger before the autonomous vehicle does and can request an image of high image quality from the autonomous vehicle. When the observer performs an action to request an image of high image quality, the autonomous vehicle transmits visual data of high image quality to the remote-control center.

As another related art, Patent Literature 3 discloses a vehicular communication apparatus used for communication between a vehicle and a control center. In Patent Literature 3, the control center controls the apparatus to assist the autonomous vehicle in traveling. The vehicle has cameras to photograph (or film) areas on front, rear, right, and left sides of the vehicle as well as an inside of the vehicle. The vehicular communication apparatus transmits visual data taken by the cameras on the front, rear, right, and left sides as well as the camera inside the vehicle to the control center.

The vehicular communication apparatus identifies a situation in which the vehicle is placed using information from the cameras. The vehicular communication apparatus, based on the identified situation, determines priorities given to the front-, rear-, right-, and left-side cameras as well as the in-vehicle camera. In accordance with the determined priorities, the vehicular communication apparatus controls the resolution and frame rate of visual data taken by each camera. If a high priority is given to the camera photographing (or filming) the area on the front side of the vehicle, for example, the vehicular communication apparatus transmits visual data taken by the camera, which photographs (or films) the frontward area of the vehicle, in high resolution and at a high frame rate to the control center.

### CITATION LIST

### Patent Literatures

Patent Literature 1: International Patent Publication No. WO2013/094405
Patent Literature 2: International Patent Publication No. WO2018/155159
Patent Literature 3: Japanese Unexamined Patent Application Publication No. 2020-3934

### SUMMARY OF INVENTION

### Technical Problem

The monitoring system described in Patent Literature 1 acquires the image information, in which the target to be primarily monitored is enlarged, from the vehicle traveling at a place where the predesignated target to be primarily monitored is present. The observer, by observing the image information, is able to monitor the designated target to be primarily monitored, i.e., a structure such as a specific facility, a shop, or an event site and a subject such as a human, an animal, or an object being present at such a place. Unfortunately, the monitoring system described in Patent Literature 1, which is used to centrally monitor a town for public safety, is not intended to monitor a target such as a situation in which the vehicle is driven. The monitoring system described in Patent Literature 1 cannot be adapted to a purpose of grasping a traveling situation that changes while the vehicle is traveling.

The remote video output system described in Patent Literature 2 causes visual data of high image quality to be transmitted from the autonomous vehicle to the remote-control center in response to an increase in the degree of danger concerning the autonomous vehicle or when the observer requests such a video. Unfortunately, in Patent Literature 2, low image quality or high image quality is selected for the overall image. In Patent Literature 2, for the high degree of danger, the overall image is rendered in high image quality. This causes a problem in such a way that a network band used for transmission of the visual data gets congested. In Patent Literature 2, a human (the observer) on the remote-control center side predicts danger and thus visual data of high image quality is requested according to human judgment. As a result, the observer is not able to monitor the target through visual data of high image quality for danger that the observer cannot notice.

The vehicular communication apparatus described in Patent Literature 3 is able to transmit visual data taken by each camera to the control center, in which image quality of the visual data is adjusted in response to a situation in which the vehicle is placed. Unfortunately, in Patent Literature 3, the image quality is adjusted on the vehicle side, and the control center simply receives visual data whose image quality has been adjusted. Potential danger may be hidden in an image of low image quality that is not given precedence. In this case, it is possible, for example, that the control center is unable to accurately predict danger due to low image quality.

In view of the above-described circumstances, an object of the present disclosure is to provide a remote monitoring system, a remote monitoring apparatus, a remote monitoring method, and an image acquisition method that each enable remote acquisition of an image from a vehicle when prediction of an event such as prediction of danger is performed on a center side such that the event can be predicted through the image with increased accuracy.

### Solution to Problem

In order to achieve the above-described object, the present disclosure provides a remote monitoring system including: a vehicle having an imaging device; and a remote monitoring apparatus connected to the vehicle through a network, in which the remote monitoring apparatus includes: an image reception means for receiving an image taken by the imaging device through the network; an event prediction means for predicting an event based on the image received by the image reception means; and an important area identification means for identifying an area as an important area in the image based on a result of the predicted event, the area being related to the predicted event, and the vehicle includes an image adjustment means for adjusting quality concerning the identified important area in the image.

The present disclosure provides a remote monitoring apparatus including: an image reception means for receiving an image from a vehicle through a network, the vehicle having an imaging device, the image being taken by the imaging device; an event prediction means for predicting an event based on the image received by the image reception means; and an important area identification means for identifying an area as an important area in the image based on a result of the predicted event, the area being related to the predicted event, in which the image reception means receives, from the vehicle, the image, whose quality concerning the identified important area in the image has been adjusted.

The present disclosure provides a remote monitoring method including: receiving an image from a vehicle through a network, the vehicle having an imaging device, the image being taken by the imaging device; predicting an event based on the received image; identifying an area as an important area in the image based on a result of the predicted event, the area being related to the predicted event; and adjusting quality concerning the identified important area in the image.

The present disclosure provides an image acquisition method including: receiving an image from a vehicle through a network, the vehicle having an imaging device, the image being taken by the imaging device; predicting an event based on the received image; identifying an area as an important area in the image based on a result of the predicted event, the area being related to the predicted event; and receiving the image from the vehicle, quality concerning the identified important area in the image having been adjusted.

### Advantageous Effects of Invention

A remote monitoring system, a remote monitoring apparatus, a remote monitoring method, and an image acquisition method according to the present disclosure each enable acquisition of an image from a vehicle when prediction of an event such as prediction of danger is performed on a center side such that the event can be predicted through the image with increased accuracy.

### BRIEF DESCRIPTION OF DRAWINGS

FIG. 1 is a schematic block diagram showing a remote monitoring system according to the present disclosure.

FIG. 2 is a schematic flowchart showing an operation procedure performed by a remote monitoring system according to the present disclosure.

FIG. 3 is a block diagram showing a remote monitoring system according to a first example embodiment of the present disclosure.

FIG. 4 is a block diagram showing an example of a configuration of a vehicle.

FIG. 5 is a block diagram showing an example of a configuration of a remote monitoring apparatus.

FIG. 6 is a flowchart showing an operation procedure performed by a remote monitoring system.

FIG. 7 is a drawing showing an example of an image received by an image reception unit before quality adjustment.

FIG. 8 is a drawing showing an example of an image received by an image reception unit after quality adjustment.

FIG. 9 is a block diagram showing a remote monitoring system according to a second example embodiment of the present disclosure.

FIG. 10 is a block diagram showing an example of a configuration of a computer apparatus.

FIG. 11 is a block diagram showing a hardware configuration of a microprocessor unit.

### EXAMPLE EMBODIMENT

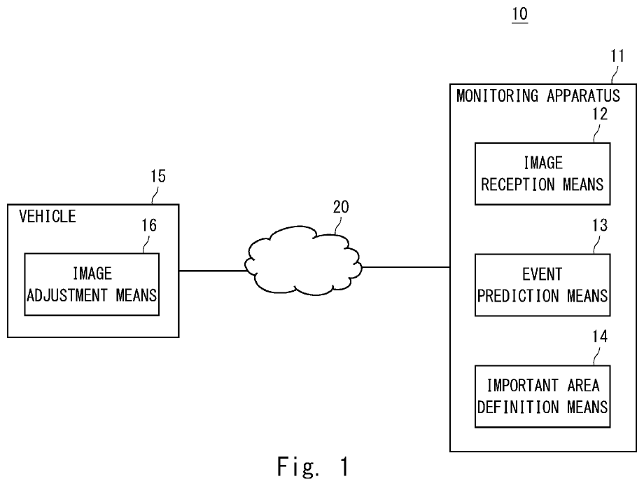

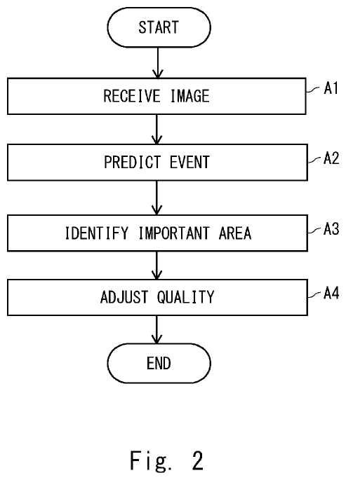

Prior to describing an example embodiment according to the present disclosure, an outline of the present disclosure will be described. FIG. 1 schematically shows a remote monitoring system according to the present disclosure. FIG. 2 schematically shows an operation procedure performed by a remote system. A remote monitoring system 10 includes a remote monitoring apparatus 11 and a vehicle 15. An imaging device is disposed in the vehicle. The remote monitoring apparatus 11 is connected to the vehicle 15 through a network 20. The remote monitoring apparatus 11 includes an image reception means 12, an event prediction means 13, and an important area identification means 14. The vehicle 15 includes an image adjustment means 16.

For instance, in the remote monitoring system 10, the vehicle 15 is constructed as a mobile object such as an automobile, a bus, or a train. The vehicle may be an autonomous vehicle configured so as to be able to perform automated driving, may be a remotely driven vehicle for which remote driving is controllable, or may be an ordinary vehicle driven by a driver. The remote monitoring apparatus 11 is configured, for example, as an apparatus to remotely monitor the vehicle 15. The important area identification means 14 constitutes, for example, a distribution control apparatus to control distribution of an image from the vehicle. The distribution control apparatus may be disposed in the remote monitoring apparatus or may be disposed in the vehicle.

The vehicle 15 transmits an image taken by the imaging device to the image reception means 12 through the network. The image reception means 12 receives the image from the vehicle 15. The event prediction means 13 predicts an event based on the image received by the image reception means 12.

Based on an event result predicted by the event prediction means 13, the important area identification means 14 identifies an area related to the predicted event as an important area in the image. The image adjustment means 16 adjusts quality of the image such that the important area identified by the important area identification means 14 is clearer than another area in the image. The image reception means 12 receives the image whose quality has been adjusted through the network.

FIG. 2 schematically shows an operation procedure performed by a remote system. The image reception means 12 receives an image taken by the imaging device from the vehicle 15 through the network 30 (Step A1). The event prediction means 13 predicts an event based on the received image (Step A2). Based on a result of the predicted event, the important area identification means 14 identifies an area related to the predicted event as an important area in the image (Step A3). The image adjustment means 16 adjusts quality concerning the identified important area in the image (Step A4).

In the present disclosure, the important area identification means 14 identifies an area related to the event, which is predicted by the event prediction means 13, as an important area. The image adjustment means 16 adjusts, for example, quality of the image such that the important area is clearer than the other area. In this way, the image reception means 12 is able to receive the image whose quality has been adjusted to render the important area clear, and the event prediction means 13 is able to predict an event from such an image. Thus, in the present disclosure, when prediction of an event such as prediction of danger is performed at a place remote from a vehicle, the system enables acquisition of an image from the vehicle such that the event can be predicted through the image with increased accuracy.

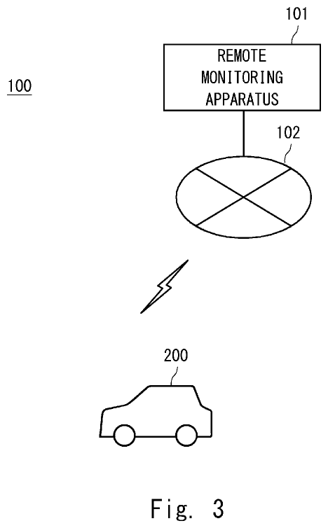

With reference to the drawings, an example embodiment according to the present disclosure will be described hereinafter in detail. FIG. 3 shows a remote monitoring system according to a first example embodiment of the present disclosure. A remote monitoring system 100 includes a remote monitoring apparatus 101 and a vehicle 200. In the remote monitoring system 100, the remote monitoring apparatus 101 and the vehicle 200 communicate with each other through a network 102. The network 102 may be, for example, a network in conformity with communication line standards such as long term evolution (LTE) or may include a radio communication network such as Wi-Fi (Registered Trademark) or a fifth-generation mobile communication system. The remote monitoring system 100 corresponds to the remote monitoring system 10 shown in FIG. 1. The remote monitoring apparatus 101 corresponds to the remote monitoring apparatus 11 shown in FIG. 1. The vehicle 200 corresponds to the vehicle 15 shown in FIG. 1. The network 102 corresponds to the network 20 shown in FIG. 1.

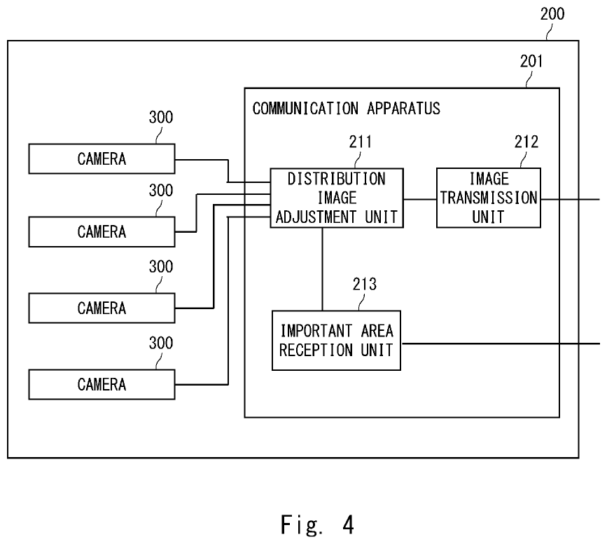

FIG. 4 shows an example of a configuration of the vehicle 200. The vehicle 200 includes a communication apparatus 201 and a plurality of cameras 300. The communication apparatus 201 is configured as an apparatus that provides radio communication between the vehicle 200 and the network 102 (refer to FIG. 3). The communication apparatus 201 includes a wireless communication antenna, a transmitter, and a receiver. The communication apparatus 201 includes a processor, memory, an input/output unit, and a bus for connecting these parts. The communication apparatus 201 includes a distribution image adjustment unit 211, an image transmission unit 212, and an important area reception unit 213 as logical components. Functions of the distribution image adjustment unit 211, the image transmission unit 212, and the important area reception unit 213 are implemented, for example, by having a microcomputer execute a control program stored in the memory.

Each of the cameras 300 outputs visual data (an image) to the communication apparatus 201. Each camera 300 photographs (or films), for example, an area on a front, rear, right, or left side of the vehicle. The communication apparatus 201 transmits an image taken by the camera 300 to the remote monitoring apparatus 101 through the network 102. In FIG. 4, the four cameras 300 are illustrated. However, the number of the cameras 300 is not limited to four. The vehicle 200 may include at least one camera 300. In this example embodiment, a communications band of the network 102 is insufficient for transmission of all images taken by the cameras 300 in high quality from the vehicle 200 to the remote monitoring apparatus 101.

The distribution image adjustment unit 211 adjusts the quality of images taken by the plurality of the cameras 300. Adjusting the image quality described here involves, for example, adjusting at least part of a compression ratio, resolution, a frame rate, or other properties of the image taken by each camera 300 and thereby adjusting an amount of data of the image to be transmitted to the remote monitoring apparatus 101 through the network 102. It is conceivable that the distribution image adjustment unit 211, for example, improves the quality of an important area and reduces the quality of an area other than the important area for quality adjustment. Improving the quality is, for example, action such as increasing the resolution (clearness) of the image and increasing the number of frames.

The important area reception unit 213 receives information about the important area (hereinafter also referred to as important area information) from the remote monitoring apparatus 101 through the network 102. Identification of the important area by the remote monitoring apparatus 101 will be described later.

When receiving the important area information, the important area reception unit 213 informs the distribution image adjustment unit 211 of a position of the important area. If the distribution image adjustment unit 211 is not informed about the important area position from the important area reception unit 213, the distribution image adjustment unit 211 adjusts the overall image taken by each camera 300 to an image of low image quality. The distribution image adjustment unit 211 may estimate, for example, a communications band from a pattern of traffic in a radio communication network and determine the quality of each image according to a result of the estimated band.

When the distribution image adjustment unit 211 is informed about the important area position from the important area reception unit 213, the distribution image adjustment unit 211 adjusts the quality of the image taken by each camera 300 such that the important area is clearer than another area in the image. In other words, the distribution image adjustment unit 211 adjusts the image such that the quality of the important area is higher than the quality of the other area. The image transmission unit 212 transmits the image taken by each camera 300, quality of which has been adjusted by the distribution image adjustment unit 211, to the remote monitoring apparatus 101 through the network 102. The distribution image adjustment unit 211 corresponds to the image adjustment means 16 shown in FIG. 1.

In this example embodiment, the image transmitted from the vehicle 200 to the remote monitoring apparatus 101 is a two-dimensional camera image. However, the image is not particularly limited to the two-dimensional image, with proviso that the image enables grasping of a situation surrounding the vehicle. The image transmitted from the vehicle 200 to the remote monitoring apparatus 101, for example, may include a point cloud image generated using Light Detection and Ranging (LiDAR) or other technology.

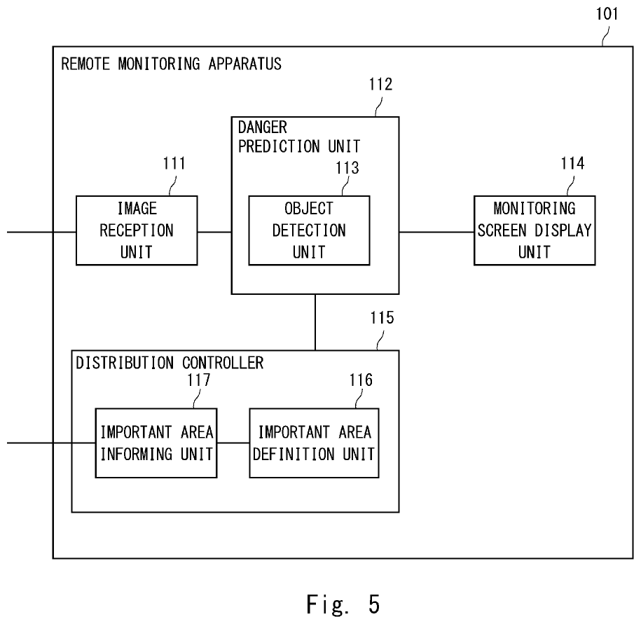

FIG. 5 shows an example of a configuration of the remote monitoring apparatus 101. The remote monitoring apparatus 101 includes an image reception unit 111, a danger prediction unit 112, a monitoring screen display unit 114, and a distribution controller 115. The image reception unit 111 receives an image transmitted from the vehicle 200 through the network 102 (refer to FIG. 3). The image reception unit 111 corresponds to the image reception means 12 shown in FIG. 1.

The danger prediction unit 112 predicts whether an event related to danger (hereinafter also refer to as a dangerous event) occurs through each image received by the image reception unit 111. The danger prediction unit 112 includes an object detection unit (an object detection means) 113. The object detection unit 113 detects an object contained in the image. The object detection unit 113 detects, from the image, a position and a type of an object or another target that is related to a dangerous event to be predicted by the danger prediction unit 112. The object detection unit 113 is not necessarily included in the danger prediction unit 112. The danger prediction unit 112 and the object detection unit 113 may be disposed separately from each other.

The danger prediction unit 112, based on the position and the type of the detected object or the like, predicts the occurrence of a dangerous event. The dangerous event, for example, may include a pedestrian running out into a road, the approach of another vehicle, and a collision with a fallen object on a road. The danger prediction unit 112 predicts the occurrence of a dangerous event from the image, for example, using a known danger prediction algorithm. The danger prediction unit 112 outputs information such as content of the dangerous event and the position of an object to the monitoring screen display unit 114 and the distribution controller 115. The danger prediction unit 112 corresponds to the event prediction means 13 shown in FIG. 1.

The distribution controller (distribution control apparatus) 115 controls a distribution of the image to be transmitted from the vehicle 200 to the remote monitoring apparatus 101. The distribution controller 115 includes an important area identification unit 116 and an important area informing unit 117. Based on a dangerous event result predicted by the danger prediction unit 112, the important area identification unit 116 identifies an area related to the predicted event as an important area in the image transmitted from the vehicle. The important area identification unit 116 corresponds to the important area identification means 14 shown in FIG. 1.

The important area identification unit 116 may identify an important area based on the position of the object detected with the object detection unit 113. The important area identification unit 116 identifies, for example, an area bearing a predetermined relation to the position of the detected object as an important area. Alternatively, the important area identification unit 116, when the occurrence of a dangerous event is predicted by the danger prediction unit 112, may estimate a direction in which the object is shifting and predict a destination to which the object is shifting. The destination, which the object is shifting to, can be estimated, for example, from a situation of a past dangerous event. The important area identification unit 116 estimates the destination, which the object is shifting to, on a time-series basis, for example. Alternatively, the important area identification unit 116 may estimate the destination, which the object is shifting to, by a statistical technique. The important area identification unit 116 may identify an area associated with the predicted destination as an important area.

The important area informing unit 117 informs the important area reception unit 213 (refer to FIG. 4) in the vehicle 200 of information about the important area, which is identified by the important area identification unit 116, through the network 102. The important area identification unit 116 may identify the important area in a plurality of images. The important area identification unit 116 may identify a plurality of the important areas in one image. The important area information includes information for identifying an image (camera) and information about the number and positions of important areas in the image, for example.

The monitoring screen display unit (image display means) 114 displays the image received by the image reception unit 111. The monitoring screen display unit 114 displays, for example, images of the areas on the front, rear, right, and left sides of the vehicle, which are taken by the cameras 300 (refer to FIG. 4), on a display screen. An observer, by monitoring the display screen, monitors whether or not there is a hindrance to traveling of the vehicle 200.

When the danger prediction unit 112 predicts the occurrence of a dangerous event, an important area is identified by the important area identification unit 116, and the image reception unit 111 receives an image in which the important area is rendered clear from the vehicle 200. In this case, by monitoring the image in which the important area related to the predicted dangerous event is rendered clear, the observer is able to monitor whether or not there is a hindrance to traveling of the vehicle. The monitoring screen display unit 114, when the danger prediction unit 112 predicts the occurrence of a dangerous event, may help invite the observer's attention to the event. For instance, the monitoring screen display unit 114 may display the predicted dangerous event result superimposing on the image received from the vehicle to inform the observer about which part in the image the potential danger is predicted.

The remote monitoring apparatus 101 may remotely control traveling of the vehicle as well as remotely monitor the vehicle. The remote monitoring apparatus 101 includes, for example, a remote controller, and the remote controller may transmit a remote control command to the vehicle to cause the vehicle to start turning right or come to an emergency stop, for example. The vehicle, when receiving the remote control command, operates in accordance with the command. Alternatively, the remote monitoring apparatus 101 may have a facility such as a steering wheel, an accelerator pedal, and a brake pedal to remotely steer the vehicle. The remote controller may remotely drive the vehicle in response to control put to a remote driving vehicle.

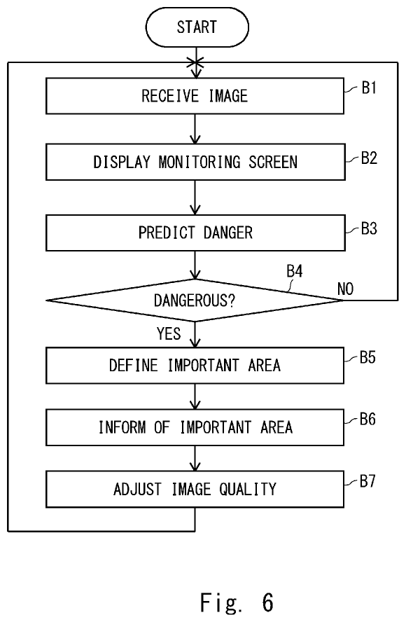

Next, an operation procedure performed by the remote monitoring system 100 will be described. FIG. 6 shows an operation procedure (a remote monitoring method) performed by the remote monitoring system 100. Each vehicle 200 transmits images taken by the cameras 300 (refer to FIG. 4) to the remote monitoring apparatus 101 through the network 102. The image reception unit 111 of the remote monitoring apparatus 101 receives an image from the vehicle 200 (Step B1). The monitoring screen display unit 114 displays the received image on a monitoring screen (Step B2).

The danger prediction unit 112 predicts whether a dangerous event occurs through each of the received images (Step B3). For instance, in the step B3, the object detection unit 113 detects an object in each image. The danger prediction unit 112, based on a result of object detection, predicts whether a dangerous event occurs. The important area identification unit 116 determines whether or not the occurrence of a dangerous event is predicted by the danger prediction unit 112 (Step B4). When in the step B4, the identification unit determines that the occurrence of a dangerous event is not predicted, the process returns to the step B1.

When the occurrence of a dangerous event is predicted in the step B4, the important area identification unit 116 identifies an important area (Step B5). In the step B5, the important area identification unit 116 identifies, for example, an area in which a predetermined object such as a human is detected, as an important area. Alternatively, the important area identification unit 116 may predict a destination to which the detected object is shifting and identify an area for the destination as an important area. The important area informing unit 117 transmits information about the identified important area to the vehicle 200 through the network 102 (Step B6). For instance, the important area informing unit 117 transmits information indicating a position of the important area to the vehicle 200 through the network 102.

The important area reception unit 213 (refer to FIG. 4) of the vehicle 200 receives information indicating the position of the important area from the remote monitoring apparatus 101. The distribution image adjustment unit 211, based on the information received by the important area reception unit 213, adjusts the quality of each image acquired from each camera 300 such that the important area is clearer than the other area in the image (Step B7). The image transmission unit 212 transmits the image, quality of which has been adjusted, to the remote monitoring apparatus 101 through the network 102. After that, the process returns to the step B 1, and the image reception unit 111 receives the image whose quality has been adjusted from the vehicle 200.

The remote monitoring method described above includes an image acquisition method and a distribution control method. The image acquisition method is equivalent to the steps B1, B3, B5, and B6. The distribution control method is equivalent to the steps B5 and B6.

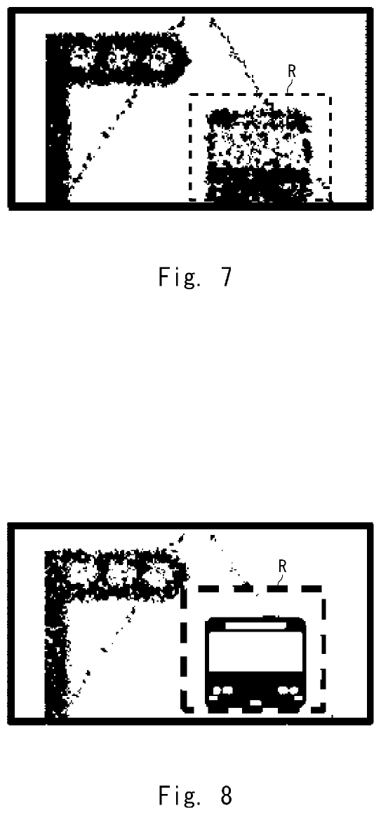

FIG. 7 shows an example of an image received by the image reception unit 111 before quality adjustment. Before information indicating the position of the important area is received, the distribution image adjustment unit 211 of the vehicle 200 transmits each image as an image in low resolution and at a low frame rate to the remote monitoring apparatus 101. The monitoring screen display unit 114 displays the image in low resolution and at a low frame rate, which is received by the image reception unit 111, on the monitoring screen. The observer monitors the image displayed by the monitoring screen display unit 114.

For instance, the danger prediction unit 112 predicts the occurrence of a dangerous event in an area indicated by an area R in FIG. 7. In this case, the important area identification unit 116 identifies the area R as an important area. The important area informing unit 117 transmits information about the position (coordinates) of the area R to the vehicle 200.

FIG. 8 shows an example of an image received by the image reception unit 111 after quality adjustment. The distribution image adjustment unit 211, as shown in FIG. 8, adjusts the quality of the image to render the area of the area R clear. The distribution image adjustment unit 211 renders the area of the area R clear, for example, by adjusting at least one of the compression ratio, the resolution, or the frame rate of the area of the area R to a level higher than that of another area. In the remote monitoring apparatus 101, the image reception unit 111 receives the image in which the area of the area R is rendered clear. In this case, the danger prediction unit 112 is able to predict whether a dangerous event occurs through the image in which the area of the area R is rendered clear. The observer is able to monitor the vehicle 200 through the image in which the area of the area R is rendered clear.

In this example embodiment, the danger prediction unit 112 predicts, for example, whether a traffic violation occurs. The object detection unit 113 detects, for example, a traffic stop sign or a stop line. The important area identification unit 116 identifies an area for the stop line as an important area in the image. The important area informing unit 117 informs the vehicle 200 of a position of the stop line area. The distribution image adjustment unit 211 of the vehicle 200 transmits an image in which the stop line area is rendered clear to the remote monitoring apparatus 101. In this case, the observer is able to check whether or not a traffic violation occurs through the image in which the stop line area is rendered clear.

The object detection unit 113 may detect a traffic sign indicating no passing or no straddling. In this case, the important area identification unit 116 identifies, for example, an area for a centerline as an important area. The important area informing unit 117 informs the vehicle 200 of a position of the centerline area. The distribution image adjustment unit 211 of the vehicle 200 transmits an image in which the centerline area is rendered clear to the remote monitoring apparatus 101. In this case, the observer is able to check whether or not a traffic violation occurs through the image in which the centerline area is rendered clear.

The danger prediction unit 112 may predict, for example, occurrence of a traffic obstruction. The object detection unit 113 detects, for example, an obstacle such as a fallen object on a road, a construction site, or an accident site. The important area identification unit 116 identifies an area for the obstacle or the like as an important area in the image. The important area informing unit 117 informs the vehicle 200 of a position of the obstacle or the like area. The distribution image adjustment unit 211 of the vehicle 200 transmits an image in which the obstacle or the like area is rendered clear to the remote monitoring apparatus 101. In this case, the observer is able to check whether or not a traffic obstruction occurs through the image in which the obstacle area is rendered clear.

In several examples described above, the remote monitoring apparatus 101 may determine the occurrence of an event such as a traffic obstruction using a determination unit (not shown). The determination unit determines whether or not a traffic obstruction has occurred by performing an examination such as an image analysis on an image that is transmitted from the vehicle 200 after the important area in the image is rendered clear. When the occurrence of the event such as a traffic obstruction is determined, the determination unit may inform the observer of the occurrence of the event such as traffic injury.

In this example embodiment, the important area identification unit 116 identifies an important area based on a dangerous event result predicted by the danger prediction unit 112. The important area informing unit 117 informs the vehicle 200 of a position of the important area. In the vehicle 200, the distribution image adjustment unit 211 adjusts the quality of an image to render the important area in the image clear, and the image transmission unit 212 transmits the image, quality of which has been adjusted, to the remote monitoring apparatus 101. In this way, the remote monitoring apparatus 101 is able to acquire the image from the vehicle 200 such that the event can be predicted through the image with increased accuracy. To put it another way, when prediction of an event such as prediction of danger is performed at the remote monitoring apparatus 101, the vehicle 200 is able to distribute the image to the remote monitoring apparatus 101 such that the event can be predicted through the image with increased accuracy. The remote monitoring apparatus 101 is able to predict danger based on such an image with increased accuracy.

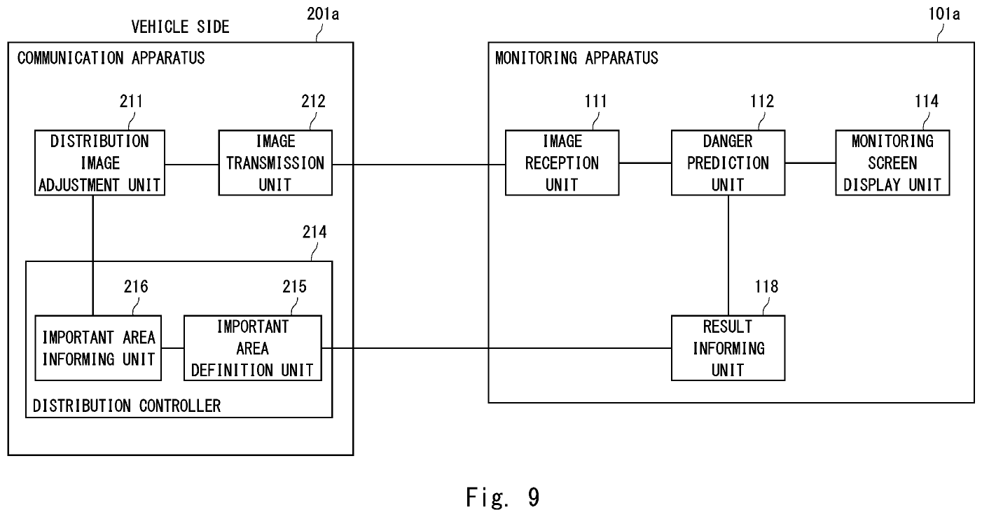

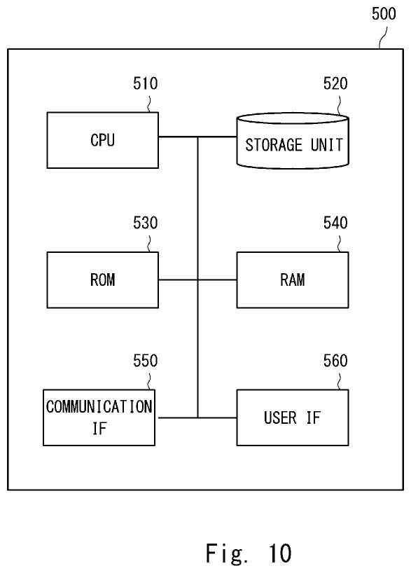

Next, a second example embodiment of the present disclosure will be described. FIG. 9 shows a remote monitoring system according to the second example embodiment of the present disclosure. A remote monitoring system 100a according to this example embodiment includes a remote monitoring apparatus 101a and a communication apparatus 201a that is disposed in a vehicle. The remote monitoring apparatus 101a has a configuration such that in the remote monitoring apparatus 101 shown in FIG. 5, the distribution controller 115 is replaced by a result informing unit 118. The communication apparatus 201a has a configuration such that in the communication apparatus 201 shown in FIG. 4, the important area reception unit 213 is replaced by a distribution controller 214. Other points may be similar to those in the first example embodiment.

In this example embodiment, the danger prediction unit 112 outputs a predicted result including content of a dangerous event and a position of an object to the result informing unit 118. The result informing unit 118 transmits the predicted result to the communication apparatus 201a on a vehicle side through a network 102 (refer to FIG. 3). In the communication apparatus 201a, the distribution controller (distribution control apparatus) 214 receives the result predicted by the danger prediction unit 112. The distribution controller 214 includes an important area identification unit 215 and an important area informing unit 216. The important area identification unit 215, based on the result predicted by the danger prediction unit 112, identifies an important area in an image. Operation of the important area identification unit 215 may be similar to operation of the important area identification unit 116 described in the first example embodiment.

The important area informing unit 216 informs the distribution image adjustment unit 211 of a position of the identified important area. The distribution image adjustment unit 211 adjusts the quality of an image to render the important area clear in the image. The image transmission unit 212 transmits the image whose quality has been adjusted to the remote monitoring apparatus 101 through the network.

In this example embodiment, the distribution controller 214 disposed in the vehicle 200 identifies the important area. In this case as well, the communication apparatus 201a on the vehicle side is able to distribute the image to the remote monitoring apparatus 101 such that the event can be predicted by the remote monitoring apparatus 101a through the image with increased accuracy. The remote monitoring apparatus 101a is able to acquire the image from the communication apparatus 201a on the vehicle side such that the event can be predicted through the image with increased accuracy. Thus, in this example embodiment, in a similar way to the first example embodiment, the remote monitoring apparatus 101a is able to predict danger with increased accuracy.

In the present disclosure, the remote monitoring apparatus 101 can be configured as a computer apparatus (a server apparatus). FIG. 10 shows an example of a configuration of a computer apparatus that can be used as the remote monitoring apparatus 101. A computer apparatus 500 includes a control unit (CPU: central processing unit) 510, a storage unit 520, a read only memory (ROM) 530, a random access memory (RAM) 540, a communication interface (IF: interface) 550, and a user interface 560.

The communication interface 550 is an interface for connecting the computer apparatus 500 to a communication network through wired communication means, wireless communication means, or the like. The user interface 560 includes, for example, a display unit such as a display. Further, the user interface 560 includes an input unit such as a keyboard, a mouse, and a touch panel.

The storage unit 520 is an auxiliary storage device that can hold various types of data. The storage unit 520 does not necessarily have to be a part of the computer apparatus 500, but may be an external storage device, or a cloud storage connected to the computer apparatus 500 through a network.

The ROM 530 is a non-volatile storage device. For example, a semiconductor storage device such as a flash memory having a relatively small capacity can be used for the ROM 530. A program(s) that is executed by the CPU 510 may be stored in the storage unit 520 or the ROM 530. The storage unit 520 or the ROM 530 stores, for example, various programs for implementing the function of each unit in the remote monitoring apparatus 101.

The RAM 540 is a volatile storage device. As the RAM 540, various types of semiconductor memory apparatuses such as a dynamic random access memory (DRAM) or a static random access memory (SRAM) can be used. The RAM 540 can be used as an internal buffer for temporarily storing data and the like. The CPU 510 deploys (i.e., loads) a program stored in the storage unit 520 or the ROM 530 in the RAM 540, and executes the deployed (i.e., loaded) program. The function of each unit in the remote monitoring apparatus 101 can be implemented by having the CPU 510 execute a program.

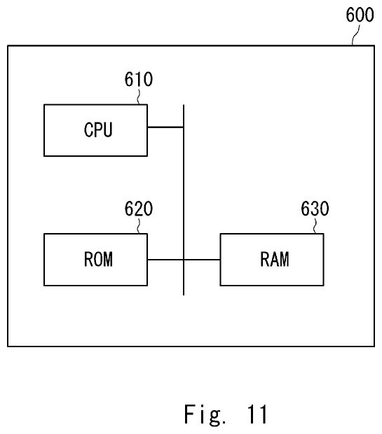

In the present disclosure, the distribution controller 214 included in the communication apparatus 201a can be configured as an apparatus such as a microprocessor unit. FIG. 11 shows a hardware configuration of a microprocessor unit that can be used as the distribution controller 214. A microprocessor unit 600 includes a processor 610, a ROM 620, and a RAM 630. In the microprocessor unit 600, the processor 610, the ROM 620, and the RAM 630 are connected to one another through a bus. The microprocessor unit 600 may include another circuit such as a peripheral circuit, a communication circuit, and an interface circuit, although illustration thereof is omitted.

The ROM 620 is a non-volatile storage device. For example, a semiconductor storage device such as a flash memory having a relatively small capacity can be used for the ROM 620. The ROM 620 stores a program executed by the processor 610.

The RAM 630 is a volatile storage device. As the RAM 630, various types of semiconductor memory apparatuses such as a dynamic random access memory (DRAM) or a static random access memory (SRAM) can be used. The RAM 630 can be used as an internal buffer for temporarily storing data and the like. The processor 610 deploys (i.e., loads) a program stored in the ROM 620 in the RAM 630, and executes the deployed (i.e., loaded) program. The function of each unit in the distribution controller 214 can be implemented by having the processor 610 execute a program.

The aforementioned program can be stored and provided to the computer apparatus 500 and the microprocessor unit 600 by using any type of non-transitory computer readable media. Non-transitory computer readable media include any type of tangible storage media. Examples of non-transitory computer readable media include magnetic storage media such as floppy disks, magnetic tapes, and hard disk drives, optical magnetic storage media such as magneto-optical disks, optical disk media such as compact disc (CD) and digital versatile disk (DVD), and semiconductor memories such as mask ROM, programmable ROM (PROM), erasable PROM (EPROM), flash ROM, and RAM. Further, the program may be provided to a computer using any type of transitory computer readable media. Examples of transitory computer readable media include electric signals, optical signals, and electromagnetic waves. Transitory computer readable media can provide the program to a computer apparatus and the like via a wired communication line such as electric wires and optical fibers or a radio communication line.

Although example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure.

The whole or part of the example embodiments disclosed above can be described as, but not limited to, the following Supplementary notes.

### [Supplementary Note 1]

A remote monitoring system including:

a vehicle having an imaging device; and

a remote monitoring apparatus connected to the vehicle through a network, in which

the remote monitoring apparatus includes:

an image reception means for receiving an image taken by the imaging device through the network;

an event prediction means for predicting an event based on the image received by the image reception means; and

an important area identification means for identifying an area as an important area in the image based on a result of the predicted event, the area being related to the predicted event, and

the vehicle includes an image adjustment means for adjusting quality concerning the identified important area in the image.

### [Supplementary Note 2]

The remote monitoring system described in Supplementary note 1, in which the image adjustment means adjusts quality of the image such that quality of the important area is higher than quality of an area other than the important area in the image.

### [Supplementary Note 3]

The remote monitoring system described in Supplementary note 1 or 2, further including an object detection means for detecting an object from the image, the object being related to the event predicted by the event prediction means,

in which the important area identification means identifies the important area based on a position of the detected object.

### [Supplementary Note 4]

The remote monitoring system described in Supplementary note 3, in which the important area identification means estimates a direction in which the object is shifting and identifies an area for a destination to which the object is shifting as the important area.

### [Supplementary Note 5]

The remote monitoring system described in any one of Supplementary notes 1 to 4, in which the important area identification means informs the image adjustment means of the important area through the network.

### [Supplementary Note 6]

The remote monitoring system described in any one of Supplementary notes 1 to 5, in which the event prediction means predicts an event related to occurrence of danger based on the image.

### [Supplementary Note 7]

The remote monitoring system described in any one of Supplementary notes 1 to 6, further including an image display means for displaying the image whose quality is adjusted by the image adjustment means.

### [Supplementary Note 8]

The remote monitoring system described in Supplementary note 7, in which the image display means displays a result of the predicted event superimposing on the image.

### [Supplementary Note 9]

A remote monitoring apparatus including:

an image reception means for receiving an image from a vehicle through a network, the vehicle having an imaging device, the image being taken by the imaging device;

an event prediction means for predicting an event based on the image received by the image reception means; and

an important area identification means for identifying an area as an important area in the image based on a result of the predicted event, the area being related to the predicted event,

in which the image reception means receives, from the vehicle, the image, whose quality concerning the identified important area in the image has been adjusted.

### [Supplementary Note 10]

The remote monitoring apparatus described in Supplementary note 9, in which the image reception means receives the image whose quality has been adjusted such that quality of the important area is higher than quality of an area other than the important area in the image.

### [Supplementary Note 11]

The remote monitoring apparatus described in Supplementary note 9 or 10, further including an object detection means for detecting an object from the image, the object being related to the event predicted by the event prediction means,

in which the important area identification means identifies the important area based on a position of the detected object.

### [Supplementary Note 12]

The remote monitoring apparatus described in Supplementary note 11, in which the important area identification means estimates a direction in which the object is shifting and identifies an area for a destination to which the object is shifting as the important area.

### [Supplementary Note 13]

The remote monitoring apparatus described in any one of Supplementary notes 9 to 12, in which the important area identification means informs the vehicle of the important area through the network.

### [Supplementary Note 14]

The remote monitoring apparatus described in any one of Supplementary notes 9 to 13, in which the event prediction means predicts an event related to occurrence of danger based on the image.

### [Supplementary Note 15]

The remote monitoring apparatus described in any one of Supplementary notes 9 to 14, further including an image display means for displaying the image in which quality concerning the identified important area has been adjusted.

### [Supplementary Note 16]

The remote monitoring apparatus described in Supplementary note 15, in which the image display means displays a result of the predicted event superimposing on the image.

### [Supplementary Note 17]

A remote monitoring method including:

receiving an image from a vehicle through a network, the vehicle having an imaging device, the image being taken by the imaging device;

predicting an event based on the received image;

identifying an area as an important area in the image based on a result of the predicted event, the area being related to the predicted event; and

adjusting quality concerning the identified important area in the image.

### [Supplementary Note 18]

The remote monitoring method described in Supplementary note 17, in which the adjusting of the quality includes adjusting quality of the image such that quality of the important area is higher than quality of an area other than the important area in the image.

### [Supplementary Note 19]

The remote monitoring method described in Supplementary note 17 or 18, further including detecting an object related to the predicted event from the image,

in which the identifying of the important area includes identifying the important area based on a position of the detected object.

### [Supplementary Note 20]

The remote monitoring method described in Supplementary note 19, in which the identifying of the important area includes estimating a direction in which the object is shifting and identifying an area for a destination to which the object is shifting as the important area.

### [Supplementary Note 21]

The remote monitoring method described in any one of Supplementary notes 17 to 20, in which the vehicle is informed of the important area through the network.

### [Supplementary Note 22]

The remote monitoring method described in any one of Supplementary notes 17 to 21, in which the predicting of the event includes predicting an event related to occurrence of danger based on the image.

### [Supplementary Note 23]

The remote monitoring method described in any one of Supplementary notes 17 to 22, further including displaying the image in which quality concerning the important area has been adjusted.

### [Supplementary Note 24]

The remote monitoring method described in Supplementary note 23, in which the displaying of the image includes displaying a result of the predicted event superimposing on the image.

### [Supplementary Note 25]

An image acquisition method including:

receiving an image from a vehicle through a network, the vehicle having an imaging device, the image being taken by the imaging device;

predicting an event based on the received image;

identifying an area as an important area in the image based on a result of the predicted event, the area being related to the predicted event; and

receiving the image from the vehicle, quality concerning the identified important area in the image having been adjusted.

### [Supplementary Note 26]

A non-transitory computer readable medium storing a program for causing a computer to perform processes including:

receiving an image from a vehicle through a network, the vehicle having an imaging device, the image being taken by the imaging device;

predicting an event based on the received image;

identifying an area as an important area in the image based on a result of the predicted event, the area being related to the predicted event;

informing the vehicle of the identified important area, the vehicle being configured to adjust quality of the image such that the important area is clearer than another area in the image to be received from the vehicle through the network; and

receiving the image from the vehicle, quality of the image having been adjusted such that the identified important area is clearer than the other area in the image.

### REFERENCE SIGNS LIST

10 REMOTE MONITORING SYSTEM
11 REMOTE MONITORING APPARATUS
12 IMAGE RECEPTION MEANS
13 EVENT PREDICTION MEANS
14 IMPORTANT AREA IDENTIFICATION MEANS
15 VEHICLE
16 IMAGE ADJUSTMENT MEANS
20 NETWORK
100 REMOTE MONITORING SYSTEM
101 REMOTE MONITORING APPARATUS
102 NETWORK
111 IMAGE RECEPTION UNIT
112 DANGER PREDICTION UNIT
113 OBJECT DETECTION UNIT
114 MONITORING SCREEN DISPLAY UNIT
115, 214 DISTRIBUTION CONTROLLER
116, 215 IMPORTANT AREA IDENTIFICATION UNIT
117, 216 IMPORTANT AREA INFORMING UNIT
118 RESULT INFORMING UNIT
200 VEHICLE
201 COMMUNICATION APPARATUS
211 DISTRIBUTION IMAGE ADJUSTMENT UNIT
212 IMAGE TRANSMISSION UNIT
213 IMPORTANT AREA RECEPTION UNIT
300 CAMERA

What is claimed is:

1. A remote monitoring system comprising:
a vehicle having an imaging device; and
a remote monitoring apparatus connected to the vehicle through a network, wherein
the remote monitoring apparatus comprises at least one memory storing instructions and at least one processor configured to execute the instructions to:
receive an image taken by the imaging device through the network;
predict an event based on the received image; and
identify an area as an important area in the image based on a result of the predicted event, the area being related to the predicted event, and
the vehicle comprises at least one memory storing instructions and at least one processor configured to execute the instructions to adjust quality concerning the identified important area in the image.

2. The remote monitoring system according to claim 1, wherein the at least one processor is configured to execute the instructions to adjust quality of the image such that quality of the important area is higher than quality of an area other than the important area in the image.

3. The remote monitoring system according to claim 1, the at least one processor is further configured to execute the instructions to detect an object from the image, the object being related to the predicted event,
wherein the at least one processor is configured to execute the instructions to identify the important area based on a position of the detected object.

4. The remote monitoring system according to claim 3, wherein the at least one processor is configured to execute the instructions to estimate a direction in which the object is shifting and identify an area for a destination to which the object is shifting as the important area.

5. The remote monitoring system according to claim 1, wherein the at least one processor is configured to execute the instructions to predict an event related to occurrence of danger based on the image.

6. The remote monitoring system according to claim 1, the at least one processor is further configured to execute the instructions to display the image whose quality is adjusted.

7. The remote monitoring system according to claim 6, wherein the at least one processor is configured to execute the instructions to display a result of the predicted event superimposing on the image.

8. A remote monitoring apparatus comprising:
at least one memory storing instructions, and
at least one processor configured to execute the instructions to:
receive an image from a vehicle through a network, the vehicle having an imaging device, the image being taken by the imaging device;
predict an event based on the received image received; and
identify an area as an important area in the image based on a result of the predicted event, the area being related to the predicted event,
wherein the at least one processor is configured to execute the instructions to receive, from the vehicle, the image whose quality concerning the identified important area in the image has been adjusted.

9. The remote monitoring apparatus according to claim 8, wherein the at least one processor is configured to execute the instructions to receive the image whose quality has been adjusted such that quality of the important area is higher than quality of an area other than the important area in the image.

10. The remote monitoring apparatus according to claim 8, the at least one processor is further configured to execute the instructions to detect an object from the image, the object being related to the predicted event,
wherein the at least one processor is configured to execute the instructions to identify the important area based on a position of the detected object.

11. The remote monitoring apparatus according to claim 10, wherein the at least one processor is configured to execute the instructions to estimate a direction in which the object is shifting and identifies an area for a destination to which the object is shifting as the important area.

12. The remote monitoring apparatus according to claim 8, wherein the at least one processor is configured to execute the instructions to predict an event related to occurrence of danger based on the image.

13. The remote monitoring apparatus according to claim 8, the at least one processor is further configured to execute the instructions to display the image in which quality concerning the identified important area has been adjusted.

14. The remote monitoring apparatus according to claim 13, wherein the at least one processor is configured to execute the instructions to display a result of the predicted event superimposing on the image.

15. A remote monitoring method comprising:
receiving an image from a vehicle through a network, the vehicle having an imaging device, the image being taken by the imaging device;
predicting an event based on the received image;
identifying an area as an important area in the image based on a result of the predicted event, the area being related to the predicted event; and
adjusting quality concerning the identified important area in the image.

16. The remote monitoring method according to claim 15, wherein adjusting the quality includes adjusting quality of the image such that quality of the important area is higher than quality of an area other than the important area in the image.

17. The remote monitoring method according to claim 15, further comprising detecting an object related to the predicted event from the image,
wherein the identifying of the important area includes identifying the important area based on a position of the detected object.

18. The remote monitoring method according to claim 17, wherein the identifying of the important area includes estimating a direction in which the object is shifting and identifying an area for a destination to which the object is shifting as the important area.

19. The remote monitoring method according to claim 15, wherein the predicting of the event includes predicting an event related to occurrence of danger based on the image.

20. The remote monitoring method according to claim 15, further comprising displaying the image in which quality concerning the important area has been adjusted.

21.-22. (canceled)
